(19) United States
(12) Patent Application Publication
(10) Pub. No.: US 2025/0322191 A1
(43) Pub. Date: Oct. 16, 2025

(54) IMAGE FORMING APPARATUS AND INFORMATION PROCESSING DEVICE

(71) Applicant: CANON KABUSHIKI KAISHA, Tokyo (JP)

(72) Inventors: MASAMI HANO, Chiba (JP); TOSHIYUKI YAMADA, Tokyo (JP); NAOYUKI YAMAMOTO, Chiba (JP); KOTA MORI, Chiba (JP); ATSUSHI MATSUMOTO, Ibaraki (JP); KYOHEI KIKUCHI, Ibaraki (JP); MARIKO SAKAMOTO, Chiba (JP)

(21) Appl. No.: 19/173,903

(22) Filed: Apr. 9, 2025

(30) Foreign Application Priority Data
Apr. 12, 2024 (JP) 2024-064422

(51) Int. Cl. G06K 15/02; G03G 15/00; G06K 15/00; G06K 15/16

(52) U.S. Cl. CPC G06K 15/021; G03G 15/5016; G03G 15/6502; G03G 15/6552; G03G 15/6558; G03G 15/6591; G06K 15/005; G06K 15/16; G06K 15/1809; G03G 2215/00535

(57) ABSTRACT

An image forming apparatus includes an operation unit configured to allow selection between a first mode for forming an image on a first recording material which is leather and a second mode for forming an image on a second recording material which is paper, a first placement portion on which a recording material is to be placed, a second placement portion on which a recording material is to be placed, an image former configured to form an image on a recording material, and a display, wherein a first curvature of a first conveyance path from the first placement portion to the image former is smaller than a second curvature of a second conveyance path from the second placement portion to the image former.

### BACKGROUND OF THE INVENTION

### Field of the Invention

The present disclosure relates to an image forming apparatus which forms an image on a recording material by using an electrophotographic method or an electrostatic recording method, and to an information processing device.

### Description of the Related Art

An image forming apparatus generally prints images using paper, for example, defined in the Japanese Industrial Standards as a recording material. The image forming apparatus can use various sizes and types of paper as the recording material. Electrophotographic image forming apparatus have entered the production market, in which offset printing machines have traditionally been the mainstream, by utilizing the ability of electrophotographic image forming apparatus to handle small lots and variable printing. In the production market, the final form of a printed product ranges from simple printed text to forms, booklets, direct mail, folding containers, and non-paper recording materials such as labels, stickers, and synthetic paper. Offset printing machines can also print on non-paper recording materials.

In recent years, due to an increase in demand for “real leather, artificial/synthetic leather” having a design on the surface, the development of colored leather products by printing using UV-curable inkjet printers is progressing. In Japanese Patent Application Laid-open No. 2010-185055, there is disclosed a leather printed product having improved abrasion resistance, which is sufficiently flexible, and has good bending resistance and crumpling resistance.

When an image forming apparatus is used to print on leather as a recording material, there is a fear that depending on the leather, conveyance failure may occur.

### SUMMARY OF THE INVENTION

An image forming apparatus according to some embodiments of the present disclosure includes an operation unit configured to allow selection between a first mode for forming an image on a first recording material which is leather and a second mode for forming an image on a second recording material which is paper, a first placement portion on which a recording material is to be placed, a second placement portion on which a recording material is to be placed, an image former configured to form an image on a recording material, and a display, wherein a first curvature of a first conveyance path from the first placement portion to the image former is smaller than a second curvature of a second conveyance path from the second placement portion to the image former, wherein the display is configured to display, in a case where the first mode is selected through the operation unit, a setting screen on which the first placement portion is settable as a feeding destination of the first recording material, and wherein the display is configured to display, in a case where the second mode is selected through the operation unit, a setting screen on which one of the first placement portion and the second placement portion is settable as a feeding destination of the second recording material.

An information processing device which is communicably connected to an image forming apparatus according to another embodiment of the present disclosure, the image forming apparatus includes a first placement portion on which a recording material is to be placed, a second placement portion on which a recording material is to be placed, and an image former configured to form an image on a recording material, wherein a first curvature of a first conveyance path from the first placement portion to the image former is smaller than a second curvature of a second conveyance path from the second placement portion to the image former, the information processing device including an operation unit configured to allow selection between a first mode for forming an image on a first recording material which is leather and a second mode for forming an image on a second recording material which is paper, and a display, wherein the display is configured to display, in a case where the first mode is selected through the operation unit, a setting screen on which the first placement portion is settable as a feeding destination of the first recording material, and wherein the display is configured to display, in a case where the second mode is selected through the operation unit, a setting screen on which one of the first placement portion and the second placement portion is settable as a feeding destination of the second recording material.

Further features of the present invention will become apparent from the following description of exemplary embodiments (with reference to the attached drawings).

### BRIEF DESCRIPTION OF THE DRAWINGS

FIG. 1 is a configuration view of an image forming system.

FIG. 2 is an explanatory diagram of a main controller.

FIG. 3 is a configuration explanatory view of an operation unit.

FIG. 4 is an exemplary view of a sheet type selection screen.

FIG. 5 is a flowchart for illustrating processing up to the start of image formation.

FIG. 6 is an exemplary view of a setting screen of a feeding location.

FIG. 7 is an exemplary view of a guide screen.

FIG. 8 is an exemplary view of a setting screen.

FIG. 9 is an exemplary view of a setting screen.

FIG. 10 is a schematic configuration diagram of a cooling mechanism.

FIG. 11 is a flowchart for illustrating cooling processing.

FIG. 12 is a table for showing verification results of a cooling effect.

FIG. 13 is a flowchart for illustrating cooling processing.

FIG. 14 is a table for showing verification results of a cooling effect.

FIG. 15 is a configuration diagram of a placement apparatus.

FIG. 16 is a flowchart for illustrating setting processing of a placement location.

FIG. 17 is an explanatory view of a guide screen.

### DESCRIPTION OF THE EMBODIMENTS

Now, referring to the accompanying drawings, description is given of at least one exemplary embodiment of the present disclosure.

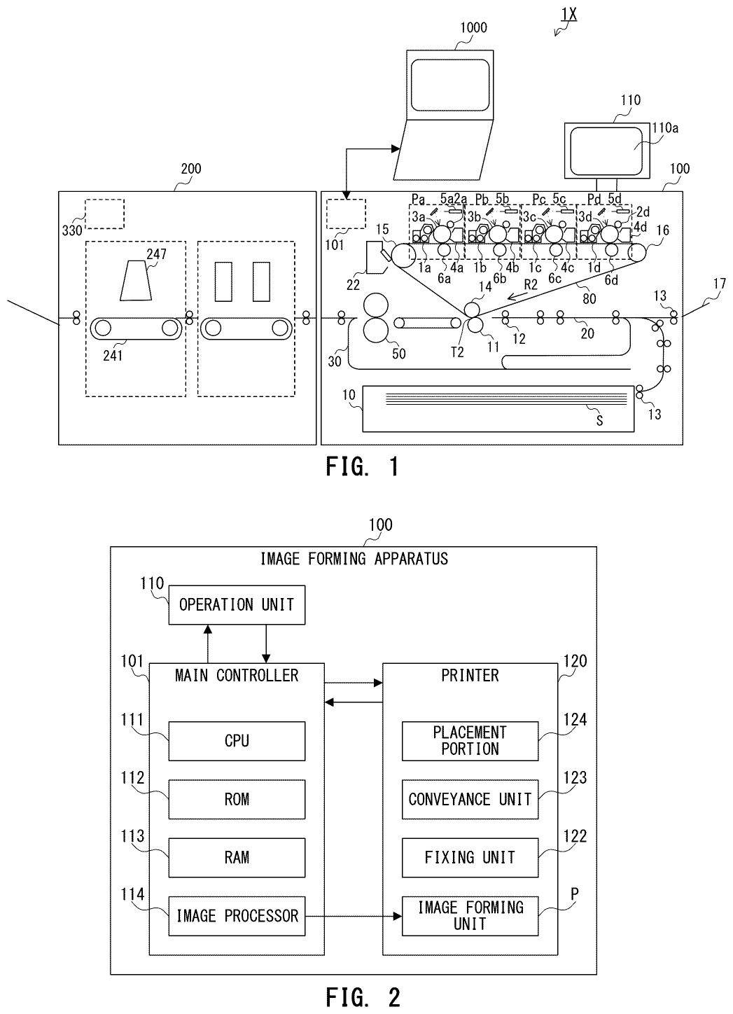

FIG. 1 is a configuration view of an image forming system including an image forming apparatus according to the at least one embodiment. An image forming system 1X includes an image forming apparatus 100 which forms a toner image on a recording material S, a back-end process apparatus 200, and an operation unit 110 which has a display 110a. The image forming system 1X may include other back-end process units such as a relay apparatus and a finisher apparatus.

The relay apparatus is arranged between the image forming apparatus 100 and various front-end or back-end process units. The relay apparatus reverses the recording material S conveyed from the image forming apparatus 100 and conveys the reversed recording material S to the front-end or back-end process unit, or temporarily stacks the recording material S and conveys the stacked recording material S to the front-end or back-end process unit. The finisher apparatus performs post-processing, such as punching processing of punching holes in the recording material S or stapling processing of bundling and stapling together a plurality of sheets of the recording material S, and delivers a post-processed bundle of sheets of the recording material S to a delivery tray. In addition to such back-end process units, the image forming system 1X may include, for example, a recording material feeding device which internally accommodates a large amount of the recording material S and feeds an accommodated recording material S to the image forming apparatus 100.

### <Image Forming Apparatus>

The image forming apparatus 100 according to the at least one embodiment is an electrophotographic tandem full-color printer. The image forming apparatus 100 may be configured to form images using an electrostatic recording method. The image forming apparatus 100 includes, as an image former, an image forming unit Pa for forming a yellow image, an image forming unit Pb for forming a magenta image, an image forming unit Pc for forming a cyan image, and an image forming unit Pd for forming a black image.

The image forming apparatus 100 forms a toner image on the recording material S based on data relating to the toner image included in image data, which is acquired from an external device 1000 such as an original reading apparatus (not shown) or a personal computer communicably connected to the image forming apparatus 100, for example. Examples of materials that can be used as the recording material S include a sheet material made of paper as a material, such as general plain paper, cardboard, rough paper, textured paper, and coated paper, as well as, in the at least one embodiment, a sheet material made of real leather, artificial leather, or synthetic leather as a material (“real leather, artificial/synthetic leather”).

A definition of “real leather, artificial/synthetic leather” as used herein is now given. In the household goods quality labeling table, “real leather, artificial/synthetic leather” are distinguished as follows:
Real leather (natural leather): A fabric produced from the collagen layer and grain layer of living organisms, such as cowhide
Artificial leather: A special non-woven fabric is used as the base material, the surface is coated with polyurethane resin, and a leather-like appearance is reproduced through processing.
Synthetic leather: Something other than a special non-woven fabric is used as the base material, a knitted or woven fabric is used as the base fabric, and a leather-like appearance is reproduced by coating the surface with polyurethane resin.

Description is now given of a conveyance process of the recording material S. The recording material S is accommodated and placed in a cassette 10, or is placed on a tray 17. The recording material S is fed from the cassette 10 or the tray 17 by feed rollers 13 in accordance with the image forming timing. The tray 17 is provided so as to be openable and closable by a user, for example. The recording material S fed by the feed rollers 13 is conveyed to registration rollers 12 arranged along a conveyance path 20. The registration rollers 12 perform skew correction and timing correction, and then convey the recording material S to a secondary transfer unit T2. The secondary transfer unit T2 is a transfer nip unit formed by an inner secondary transfer roller 14 and an outer secondary transfer roller 11. The secondary transfer unit T2 transfers the toner image onto the recording material S by applying a secondary transfer voltage to the outer secondary transfer roller 11.

Description is now given of the image forming process in which the toner image is conveyed to the secondary transfer unit T2 at the same timing relative to the process of conveying the recording material S to the secondary transfer unit T2. Description is given of the configuration of the image forming units Pa, Pb, Pc, and Pd. The image forming units Pa, Pb, Pc, and Pd have substantially the same configuration, except that the colors of the images (toner images) to be formed are different among yellow, magenta, cyan, and black. Here, description is given of the image forming unit Pd which forms a black toner image, and description of the other image forming units Pa, Pb, and Pc is omitted.

The image forming unit Pd mainly includes a developing device 1d, a charging device 2d, a photosensitive drum 3d, a photosensitive drum cleaner 4d, an exposure device 5d, a primary transfer roller 6d, and the like. The photosensitive drum 3d is a photosensitive member having a photosensitive layer on a surface, and is rotated around a drum shaft. The charging device 2d uniformly charges the surface of the photosensitive drum 3d being rotated. The exposure device 5d forms an electrostatic latent image by irradiating the charged surface of the photosensitive drum 3d with a laser beam which is driven based on an image signal. The developing device 1d forms a black toner image on the surface of the photosensitive drum 3d by using a developer to develop the electrostatic latent image formed on the photosensitive drum 3d.

The primary transfer roller 6d is provided so as to sandwich an intermediate transfer belt 80 at a position opposing the photosensitive drum 3d. The primary transfer roller 6d transfers the toner image formed on the photosensitive drum 3d onto the intermediate transfer belt 80 by applying a primary transfer voltage. Transfer residual toner remaining on the photosensitive drum 3d after the transfer is collected by the photosensitive drum cleaner 4d.

In the same manner, a yellow toner image is formed on a photosensitive drum 3a of the image forming unit Pa, and the toner image is transferred onto the intermediate transfer belt 80 by a primary transfer roller 6a. A magenta toner image is formed on a photosensitive drum 3b of the image forming unit Pb, and the toner image is transferred onto the intermediate transfer belt 80 by a primary transfer roller 6b. A cyan toner image is formed on a photosensitive drum 3c of the image forming unit Pc, and the toner image is transferred onto the intermediate transfer belt 80 by a primary transfer roller 6c.

The intermediate transfer belt 80 is an endless belt stretched around the inner secondary transfer roller 14 and tensioning rollers 15 and 16, and is driven in the direction of an arrow R2. In the at least one embodiment, the tensioning roller 16 also serves as a drive roller which drives the intermediate transfer belt 80. The image forming process of each of the image forming units Pa to Pd is performed at a timing such that the transferred toner images of the respective colors are sequentially superimposed on the intermediate transfer belt 80. As a result, in the end, a full-color toner image is formed on the intermediate transfer belt 80.

The intermediate transfer belt 80 conveys the toner image to the secondary transfer unit T2 by rotating. Conveyance of the toner image to the secondary transfer unit T2 is performed in accordance with the timing at which the recording material S is conveyed to the secondary transfer unit T2. As a result, the toner image is transferred onto a predetermined position on the recording material S. Transfer residual toner remaining on the intermediate transfer belt 80 after the transfer by the secondary transfer unit T2 is removed by a transfer cleaner 22.

The toner image is borne on the recording material S by a conveyance process and an image forming process such as those described above. The recording material S is conveyed from the secondary transfer unit T2 to a fixing device 50. The fixing device 50 fixes the toner image on the recording material S by applying heat and pressure to the recording material S bearing the toner image. For this purpose, the fixing device 50 has a first roller that includes a built-in heat source and a second roller that is biased toward the first roller, and conveys the recording material S by sandwiching the recording material S between the first roller and the second roller. At this time, the recording material S is heated by the heat source and pressed by the second roller. As a result, each toner image borne by the recording material S is melted and mixed, and is fixed on the recording material S as a full-color image. In this way, the series of image forming processes ends.

In the case of duplex printing, the recording material S having an image printed on one surface is conveyed from the fixing device 50 to a duplex-printing conveyance path 30, the printing surface is reversed, and the recording material S is conveyed to the conveyance path 20. Then, the recording material S is skew-corrected by the registration rollers 12, conveyed to the secondary transfer unit T2 in accordance with the timing at which the toner image borne on the intermediate transfer belt 80 is conveyed to the secondary transfer unit T2, and the toner image is transferred onto the reversed printing surface.

The developer to be used in the at least one embodiment is a two-component developer containing a toner and a carrier. The toner contains a binder resin, a colorant, and a release agent (wax). A publicly-known binder resin may be used as the binder resin. For example, a vinyl-based copolymer typified by a styrene-(meth) acrylic copolymer, a polyester resin, a hybrid resin in which a vinyl-based copolymer unit and a polyester unit are chemically bonded to each other, an epoxy resin, or a styrene-butadiene copolymer may be used as the binder resin. A publicly-known colorant may be used as a colorant for each of the colors of yellow, magenta, cyan, and black.

For example, an aliphatic hydrocarbon-based wax or an oxide of an aliphatic hydrocarbon-based wax, or a block copolymerized product thereof may be used as the release agent. The aliphatic hydrocarbon-based wax is, for example, low-molecular-weight polyethylene, a low-molecular-weight olefin copolymer wax, a microcrystalline wax, a Fischer-Tropsch wax, or a paraffin wax. The oxide of the aliphatic hydrocarbon-based wax is, for example, a polyethylene oxide wax. The block copolymerized product is a wax containing a fatty acid ester as a main component, an ester wax, or a product obtained by deacidifying part or whole of a fatty acid ester such as deacidified carnauba wax. Examples of the wax containing a fatty acid ester as a main component include a carnauba wax and a montanoic acid ester wax. The ester wax is, for example, a synthesis reaction product of a higher fatty acid and a higher alcohol, such as behenyl behenate or behenyl stearate.

Operation of such an image forming apparatus 100 is controlled by a main controller 101. FIG. 2 is an explanatory diagram of the main controller 101. The main controller 101 can communicate to and from a printer 120 and the operation unit 110. The printer 120 includes various units used in the image forming process described above.

The main controller 101 includes a central processing unit (CPU) 111, a read-only memory (ROM) 112, a random-access memory (RAM) 113, and an image processor 114. The CPU 111 controls the overall operation of the image forming system 1X by executing computer programs stored in the ROM 112. The RAM 113 provides a work area in a case where the CPU 111 executes processing. The image processor 114 transmits, to the image forming units Pa to Pd, an image signal generated by performing predetermined image processing on image data acquired from the external device 1000, such as changing the image data into a format that can be processed by exposure devices 5a to 5d of the image forming units Pa to Pd.

The printer 120 includes a placement portion 124, a conveyance unit 123, a fixing unit 122, and an image forming unit P. The image forming unit P represents the above-mentioned image forming units Pa to Pd. The placement portion 124 is the cassette 10 and the tray 17, and the recording material S is accommodated or placed therein. The conveyance unit 123 feeds the recording material S from the placement portion 124, conveys the recording material S to the secondary transfer unit T2 and the fixing device 50, and delivers the recording material S to outside the image forming system 1X. The conveyance unit 123 includes the feed rollers 13 and the registration rollers 12. The fixing unit 122 is the above-mentioned fixing device 50, and fixes the toner image on the recording material S. The image forming unit P forms the toner images of the respective colors as described above. The image forming unit P controls the drive of the laser beams output from the exposure devices 5a to 5d based on the image signal acquired from the image processor 114.

In order to perform optimal print settings, the image forming apparatus 100 according to the at least one embodiment is required to set the sheet type based on an instruction from the user by using the operation unit 110. The operation unit 110 is a user interface having the display 110a being an input interface and an output interface. The operation unit 110 is used, for example, to acquire the sheet type setting of the recording material S used for image formation. FIG. 3 is a configuration explanatory view of the operation unit 110.

The operation unit 110 in the at least one embodiment has, as input interfaces, a setting key 1002, a power saving key 1003, a hard key group 1104, a reset key 1105, a stop key 1106, and a start key 1107. Further, the operation unit 110 may include a touch panel provided on the display 110a as an input interface. Content (for example, information required for creating job information such as the type of the recording material S, the number of print copies, and output attribute information) input by using the input interfaces is transmitted to the CPU 111. The user can input information by using the input interfaces.

The setting key 1002 is pressed in a case where various settings such as the sheet type setting are performed. The power saving key 1003 is pressed in a case where the image forming apparatus 100 is set to or woken up from a sleep mode The image forming apparatus 100 transitions to the sleep mode from a normal mode in a case where the power saving key 1003 is pressed in the normal mode, and transitions to the normal mode in a case where the power saving key 1003 is pressed in the sleep mode. The hard key group 1104 includes a numeric keypad, a clear key, and an authentication key. The reset key 1105 is pressed in a case where various settings are reset. The stop key 1106 is pressed in a case where an operation in progress is stopped. The start key 1107 is pressed in a case where a printing operation is started or in a case where another function is instructed to start. The start key 1107 includes two-color light emitting diodes (LEDs), which are green and red LEDs (not shown). When the start key 1107 is lit in green, this indicates that it is possible to start, and in a case where the start key 1107 is lit in red, this indicates that it is not possible to start.

The various keys described above are hardware keys, but those various keys may be implemented by software keys displayed on the display 110a. Further, the various keys may be implemented by combining hardware keys and software keys.

Description is now given of a configuration of the back-end process apparatus 200 of FIG. 1. The back-end process apparatus 200 acquires the recording material S on which an image has been printed from the image forming apparatus 100, and cools the recording material S heated by the fixing device 50. The back-end process apparatus 200 includes a cooling mechanism 247 for cooling the recording material S, a conveyance mechanism 241 for conveying the recording material S, and a controller 330 for controlling operation of the back-end process apparatus 200. The back-end process apparatus 200 uses the cooling mechanism 247 to cool the recording material S while conveying the recording material S by using a conveyance mechanism 241. The cooling mechanism 247 cools the recording material S by, for example, blowing air onto the recording material S. The cooled recording material S is delivered from the back-end process apparatus 200. The controller 330 controls the operation of the back-end process apparatus 200 in accordance with instructions from the main controller 101.

### First Embodiment

When an image is printed using “real leather, artificial/synthetic leather” as the recording material S, the following problems may occur due to the characteristics of “real leather, artificial/synthetic leather.”
Flexibility: “Real leather, artificial/synthetic leather” is less stiff than paper and has no resistance to bending, making conveyance difficult.
Smoothness: “Real leather, artificial/synthetic leather” has a higher surface frictional force than paper, and thus the paper becomes stuck during placement after passing, causing placement failure.
Heat capacity: “Real leather, artificial/synthetic leather” has a higher heat capacity than paper, and thus image defects may occur due to toner peeling off immediately after printing.

Thus, compared to paper, a recording material S of “real leather, artificial/synthetic leather” may have lower conveyance performance due to its flexibility and unevenness, and lower image quality due to its heat capacity. Further, whether or not there is a decrease in conveyance performance and image quality varies depending on the surface properties, type, and thickness, for example, of “real leather, artificial/synthetic leather.” That is, depending on the conditions, it may be possible to pass even “real leather, artificial/synthetic leather” and print normally thereon. However, it is difficult for a general user to find such conditions.

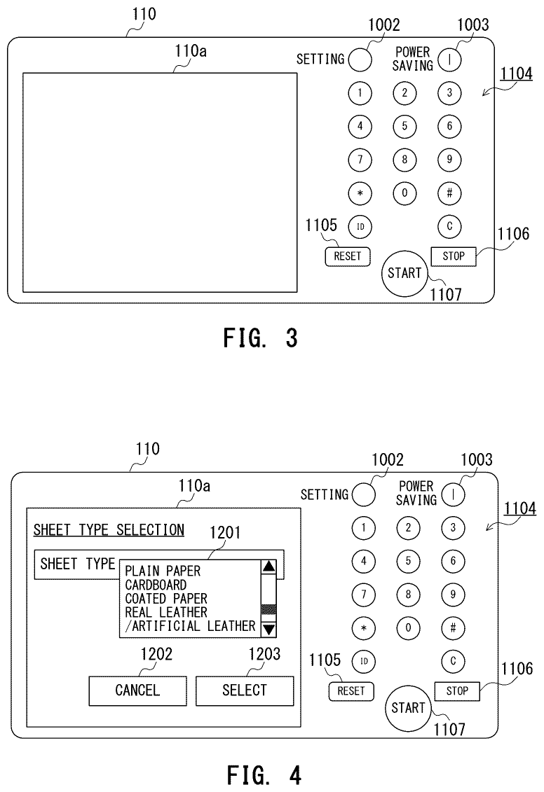

In a first embodiment of the present disclosure, through selecting the sheet type from a sheet type selection screen, it becomes possible to print on even “real leather, artificial/synthetic leather.” FIG. 4 is an exemplary view of a sheet type selection screen. A selection screen 1201 is displayed on the display 110a.

When the user selects and presses “real leather, artificial/synthetic leather” from the pull-down menu on the selection screen 1201, the selected portion is displayed with its background being highlighted. When the user subsequently presses a select button 1203, the selection of “real leather, artificial/synthetic leather” as the sheet type is input to the main controller 101. The CPU 111 thus sets the recording material S type to “real leather, artificial/synthetic leather.” When a cancel button 1202 is pressed, the sheet type setting is canceled.

Setting information (image forming conditions) corresponding to “real leather, artificial/synthetic leather” to be used at the time of image formation to prevent deterioration in conveyance performance and image quality is stored in the ROM 112 in advance. The CPU 111 acquires the setting information on “real leather, artificial/synthetic leather” from the ROM 112, and uses the acquired setting information for control during image formation by the printer 120. As a result, deterioration in conveyance performance and image quality in a case where an image is printed on “real leather, artificial/synthetic leather” is prevented.

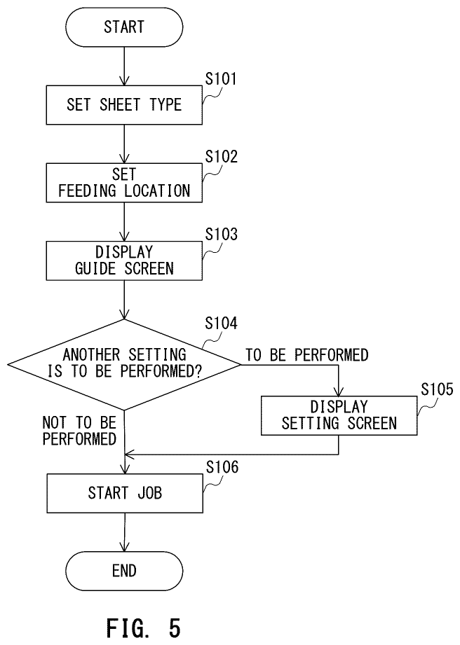

FIG. 5 is a flowchart for illustrating processing up to the start of image formation in a case where “real leather, artificial/synthetic leather” is set as the sheet type.

When the user uses the operation unit 110 to select “real leather, artificial/synthetic leather” from the sheet type selection screen 1201 and press the select button 1203, the main controller 101 sets the sheet type to “real leather, artificial/synthetic leather” (Step S101). The selection screen 1201 is displayed on the display 110a by the main controller 101 in a case where the user presses a button to start selecting the sheet type, or in a case where the recording material S is placed on the placement portion 124. A case in which “real leather, artificial/synthetic leather” is set is referred to as “first mode,” and a case in which a recording material made of a paper material other than “real leather, artificial/synthetic leather” is set is referred to as “second mode.”

The main controller 101 sets a feeding location, which is a feeding destination corresponding to the set sheet type (Step S102). The feeding location is set by using the feeding location setting screen displayed on the display 110a.

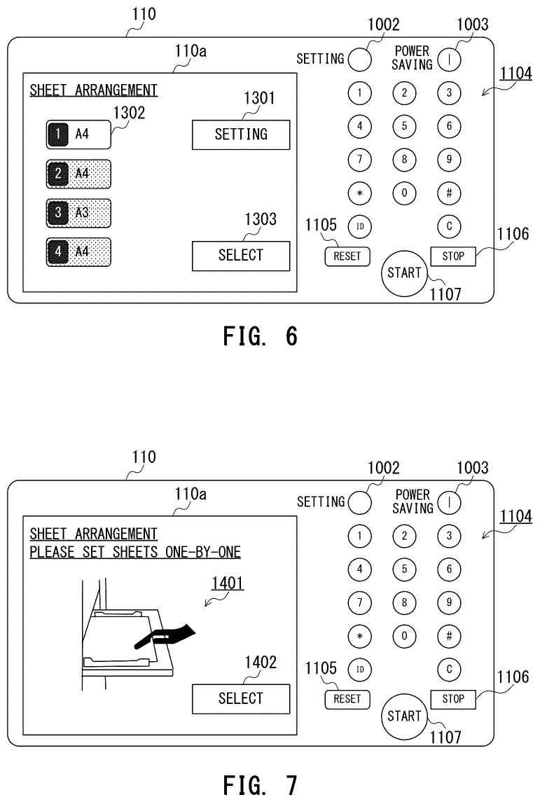

FIG. 6 is an exemplary view of the feeding location setting screen. When the recording material S is paper, one feeding location from a plurality of feeding locations can be set by using the operation unit 110. In the first embodiment, “real leather, artificial/synthetic leather” is set as the type of the recording material S, and thus only a specific feeding location is selectable, and other feeding locations are not selectable (selection screen 1302). In FIG. 6, feeding locations which are not selectable are grayed out and are not activated even when pressed. Through pressing a select button 1303 after selecting the feeding location, the main controller 101 sets the selected feeding location.

For a recording material S which has low flexibility and is less stiff than paper, such as “real leather, artificial/synthetic leather,” deterioration in conveyance performance can be prevented by feeding the recording material S from a feeding location having a conveyance path in which there are as few bends as possible. The conveyance path for conveying the recording material S from the cassette 10 extends in the vertical direction immediately after the sheet feeding, and then extends in the horizontal direction. As a result, there is a bent portion along the conveyance path to change the conveyance direction from vertical to horizontal. The conveyance path conveying the recording material S from the tray 17 extends in the horizontal direction, and there is no bent portion along the conveyance path. Accordingly, a curvature of the conveyance path from the tray 17 is smaller than a curvature of the conveyance path from the cassette 10. For this reason, in the first embodiment, only the first feeding location indicating the tray 17 is selectable as the specific feeding location. That is, the tray 17 can feed a recording material S of “real leather, artificial/synthetic leather,” but the cassette 10 cannot feed a recording material S of “real leather, artificial/synthetic leather.”

The main controller 101 displays, on the display 110a, a guide screen illustrated as an example in FIG. 7 as a precaution for printing on the recording material S (Step S103). A guide 1401 represents a precaution in a case where the recording material S is placed on the tray 17. In the first embodiment, the recording material S is “real leather, artificial/synthetic leather,” and thus the surface of the recording material S has a high frictional force and hence multi-feeding in which a plurality of sheets of the recording material S are conveyed in an overlapping manner tends to occur. The guide 1401 can be expected to have an effect of preventing such multi-feeding. When the user presses the select button 1402, the display on the display 110a returns to the setting screen of FIG. 6.

In the main controller 101, the sheet type and the feeding location are set by the settings in performed in Step S101 and Step S102. The main controller 101 determines whether or not an operation indicating that a setting required for another printing operation is to be performed has been performed by using the operation unit 110 (Step S104). For example, in a case where a setting key 1301 on the setting screen of FIG. 6 is pressed, the main controller 101 determines that another setting is to be performed.

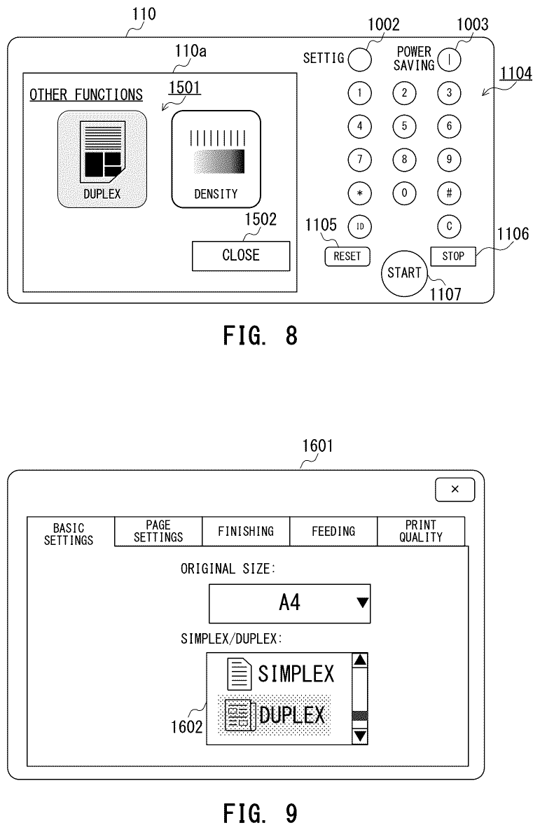

When another setting is to be performed (Step S104: “to be performed”), the main controller 101 displays a special setting screen which depends on “real leather, artificial/synthetic leather” on the display 110a (Step S105). Here, description is given of a setting for simplex/duplex printing. In the first embodiment, the sheet type is set to “real leather, artificial/synthetic leather,” and thus the setting screen illustrated as an example in FIG. 8 is displayed on the display 110a. On this setting screen, a duplex printing setting 1501 is not selectable. On the setting screen of FIG. 8, image density can be set as the another setting. When a “close” button 1502 is pressed, the image density is set.

Setting of the duplex printing setting 1501 depends on the sheet type. General “real leather, artificial/synthetic leather” is composed of different material layers on the front and back, and the characteristic surface of the leather is mainly present only on one surface. Therefore, to prevent duplex printing from being set by mistake, the duplex printing setting 1501 is not selectable, which prevents duplex printing from being selected, thereby preventing a printing error. As a result, conveyance failure due to the recording material S being conveyed by mistake to the duplex-printing conveyance path 30 for duplex printing can be prevented.

When another setting is not to be performed (Step S104: “not to be performed”), or after the another setting is complete, the main controller 101 starts the job in a case where the start key 1107 is pressed (Step S106). The main controller 101 that has started the job controls the printer 120 to print on the recording material S.

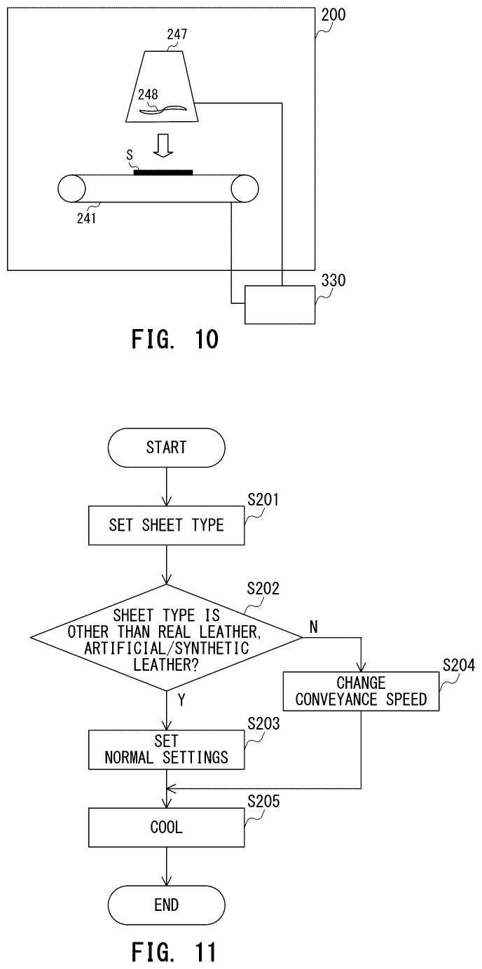

In the first embodiment, description is given of an example in which various settings related to printing are performed by the user operating the operation unit 110, but it is possible to perform the same processing even when the user operates the external device 1000. The external device 1000 is an information processing device which includes an input device and a display. The external device 1000 has the functions of the main controller 101, and a printer driver for using the image forming system 1X, for example, is installed in the external device 1000. On the display of the external device 1000, the printer driver displays, in accordance with the progress of the processing, screens for setting the items to be set on each of the screens of FIG. 4, FIG. 6, and FIG. 7. FIG. 9 is an exemplary view of a setting screen displayed on a display of the external device 1000. This setting screen is the screen displayed during the setting of the another setting (during the processing step of Step S105). Even when setting is performed by using the external device 1000, it is possible to print on “real leather, artificial/synthetic leather.”

### Second Embodiment

The “real leather, artificial/synthetic leather” used as the recording material S has a higher heat capacity than paper, and hence has a lower cooling efficiency. When a recording material S of “real leather, artificial/synthetic leather” is heated, toner may peel off immediately after printing, and hence if the recording material S is not cooled sufficiently, the image quality may deteriorate.

Therefore, in a case where a recording material S of “real leather, artificial/synthetic leather” is heated by the fixing device 50 and then cooled by the back-end process apparatus 200, the recording material S is required to be cooled by a cooling mechanism 247 having a better cooling efficiency compared with the case of a paper recording material S. The cooling efficiency can be improved by, for example, increasing the cooling capacity of the cooling mechanism 247 or slowing down the conveyance speed of the recording material S by the conveyance mechanism 241. Here, description is given of a case in which the cooling efficiency is improved by slowing down the conveyance speed of the recording material S by the conveyance mechanism 241.

FIG. 10 is a schematic configuration diagram of the cooling mechanism 247 of the back-end process apparatus 200. The cooling mechanism 247 includes a fan 248, which blows cooling air onto the recording material S. The operation of the fan 248 is controlled by the controller 330. The conveyance mechanism 241 conveys the recording material S under the control of the controller 330. The controller 330 adjusts the conveyance speed of the recording material S by the conveyance mechanism 241 in accordance with the type of the recording material S based on an instruction from the main controller 101. When the recording material S is “real leather, artificial/synthetic leather,” the conveyance speed of the recording material S by the conveyance mechanism 241 is adjusted so as to be slower than in the case of paper. As a result, the amount of air blown by the fan 248 onto the recording material S per unit time is adjusted.

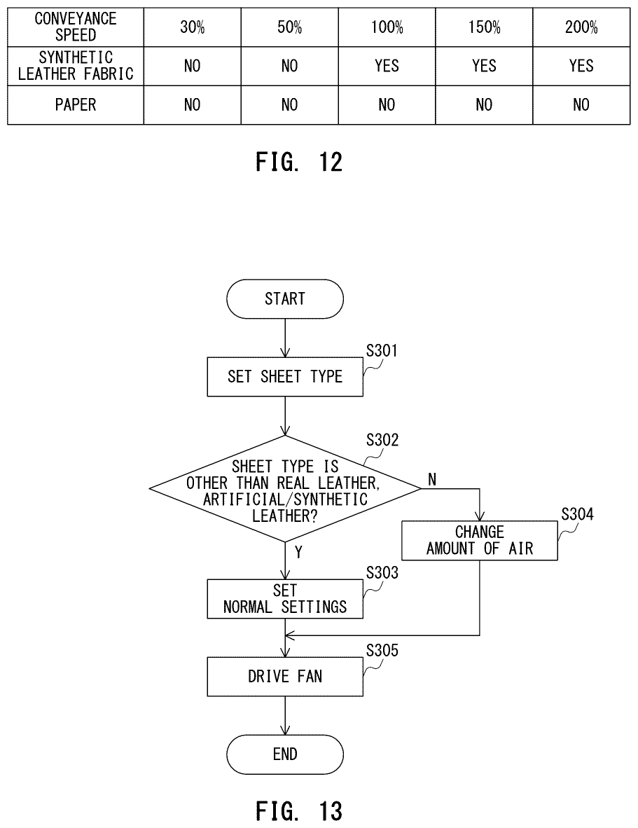

FIG. 11 is a flowchart for illustrating cooling processing by the back-end process apparatus 200. This processing is processing of adjusting the cooling efficiency of the back-end process apparatus 200 by adjusting the conveyance speed of the recording material S by the back-end process apparatus 200 in accordance with the type of the recording material S set by using the operation unit 110.

When the user selects the type of the recording material S from the selection screen 1201 of FIG. 4 by using the operation unit 110 and presses the select button 1203, the main controller 101 sets the sheet type (Step S201). The selection screen 1201 is displayed on the display 110a by the main controller 101 in a case where the user presses a button to start selecting the sheet type, or in a case where the recording material S is placed on the placement portion 124. The sheet type can be set to, other than “real leather, artificial/synthetic leather,” plain paper, cardboard, and coated paper, for example.

The main controller 101 determines whether or not the set sheet type is “real leather, artificial/synthetic leather” (Step S202). When the sheet type is other than “real leather, artificial/synthetic leather” (Step S202: Y), the main controller 101 sets the other image forming conditions except the conveyance condition of the recording material S, and sets the conveyance condition to the conveyance condition (conveyance speed) for normal paper (Step S203). When the sheet type is “real leather, artificial/synthetic leather” (Step S202: N), the main controller 101 sets the other image forming conditions except the conveyance condition of the recording material S, and forcibly sets the conveyance condition to the conveyance condition (conveyance speed) corresponding to “real leather, artificial/synthetic leather” (Step S204). The main controller 101 uses the printer 120 to perform image formation under the condition set in the processing step of Step S203 or the processing step of Step S204.

The main controller 101 cools the recording material S by causing the controller 330 to drive the fan 248 while conveying the recording material S under the conveyance condition (conveyance speed) set in the processing step of Step S203 or the processing step of Step S204 (Step S205). The cooled recording material S is delivered from the back-end process apparatus 200.

The inventor(s) of the present application verified the cooling effect by changing the conveyance speed. Synthetic leather fabric (front surface: 100% polyurethane, back surface: 100% polyester) was used as the recording material S in an environment having an environmental temperature of 23° C. and a humidity of 50%. A solid black image having an image ratio of 100% was fixed on the front surface of the recording material S. The recording material S was cooled under different cooling conditions (conveyance speed of the recording material S), and after cooling, a toner peeling test was performed to verify the cooling effect.

In order to quantify the state of toner peeling, five sheets of Silbon paper were stacked on the surface of the image fixed on the recording material S, each sheet of Silbon paper was moved back-and-forth five times under a constant load of 200 g, and the amount of toner adhering to the Silbon paper was measured. The conveyance condition of the recording material S was set such that the conveyance speed was changed to 30%, 50%, 100%, 150%, and 200% compared to when the conveyance speed of paper such as plain paper is 100%. Through changing the conveyance speed, the amount of air contacting the recording material S changes, and hence the cooling effect changes.

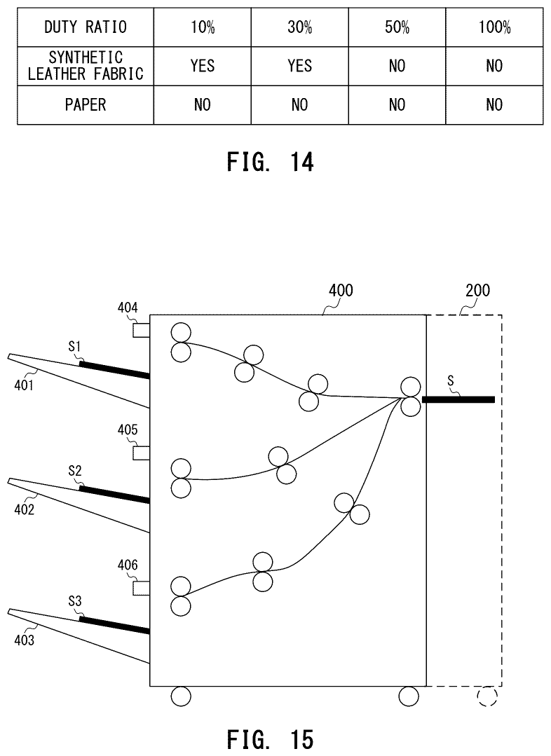

FIG. 12 is a table for showing the verification results of the cooling effect. For comparison, a similar experiment was conducted using paper having the same basis weight as synthetic leather fabric. As is clear from FIG. 12, it can be seen that in a case where the conveyance speed is slower than the normal conveyance speed (30%, 50%), the amount of air contacting the recording material S per unit time increases, thereby increasing the cooling effect on the recording material S, and suppressing toner peeling.

Based on the comparison with paper of the same basis weight, it can be seen that toner peeling tends to occur more for synthetic leather than for paper even when the basis weight is the same. This is because the heat capacity effect differs depending on the material. Therefore, in a case where synthetic leather is used as the recording material S, the cooling effect is required to be better than when paper is used as the recording material S. That is, this result shows that it is required to set the conveyance condition depending on the sheet type.

### Third Embodiment

As described in a second embodiment of the present disclosure, the cooling efficiency can be improved by, for example, increasing the cooling capacity of the cooling mechanism 247 or slowing down the conveyance speed of the recording material S by the conveyance mechanism 241. Here, description is given of a case in which the cooling efficiency is improved by increasing the cooling capacity of the cooling mechanism 247. For this purpose, the cooling condition of the cooling mechanism 247 is changed in order to change the amount of air which contacts the recording material S. In a third embodiment of the present disclosure, productivity is maintained because the conveyance speed of the recording material S is not slowed down, unlike the case in the second embodiment.

FIG. 13 is a flowchart for illustrating cooling processing by the back-end process apparatus 200. This processing is processing for adjusting the cooling efficiency of the back-end process apparatus 200 by adjusting the amount of air blown onto the recording material S by the back-end process apparatus 200 in accordance with the type of the recording material S set by using the operation unit 110.

The main controller 101 sets the sheet type in the same manner as the processing step of Step S201 of FIG. 11 (Step S301). The main controller 101 determines whether or not the set sheet type is “real leather, artificial/synthetic leather” (Step S302). When the sheet type is other than “real leather, artificial/synthetic leather” (Step S302: Y), the main controller 101 sets the other image forming conditions except the cooling condition of the recording material S, and sets the cooling condition to the cooling condition for normal paper (Step S303). When the sheet type is “real leather, artificial/synthetic leather” (Step S302: N), the main controller 101 sets the other image forming conditions except the cooling condition of the recording material S, and forcibly sets the cooling condition to the condition corresponding to “real leather, artificial/synthetic leather” (Step S304). The main controller 101 uses the printer 120 to perform image formation under the condition set in the processing step of Step S303 or the processing step of Step S304.

The main controller 101 cools the recording material S by driving the fan 248 under the control of the controller 330 based on the cooling condition (amount of air) set in the processing step of Step S303 or the processing step of Step S304 while conveying the recording material S (Step S305). The cooled recording material S is delivered from the back-end process apparatus 200.

The inventor(s) of the present application verified the cooling effect by changing the amount of air. Synthetic leather fabric (front surface: 100% polyurethane, back surface: 100% polyester) was used as the recording material S in an environment having an environmental temperature of 23° C. and a humidity of 50%. A solid black image having an image ratio of 100% was fixed on the front surface of the recording material S. The recording material S was cooled under different cooling conditions (the amount of air contacting the recording material S), and after cooling, a toner peeling test was performed to verify the cooling effect.

In order to quantify the state of toner peeling, five sheets of Silbon paper were stacked on the surface of the image fixed on the recording material S, each sheet of Silbon paper was moved back-and-forth five times under a constant load of 200 g, and the amount of toner adhering to the Silbon paper was measured. The cooling condition (amount of air) was changed based on the duty ratio of the drive signal which drives the fan 248. The duty ratio was changed to 10%, 30%, 50%, and 100%. When the duty ratio is changed, the amount of air contacting the recording material S changes, and hence the cooling effect changes.

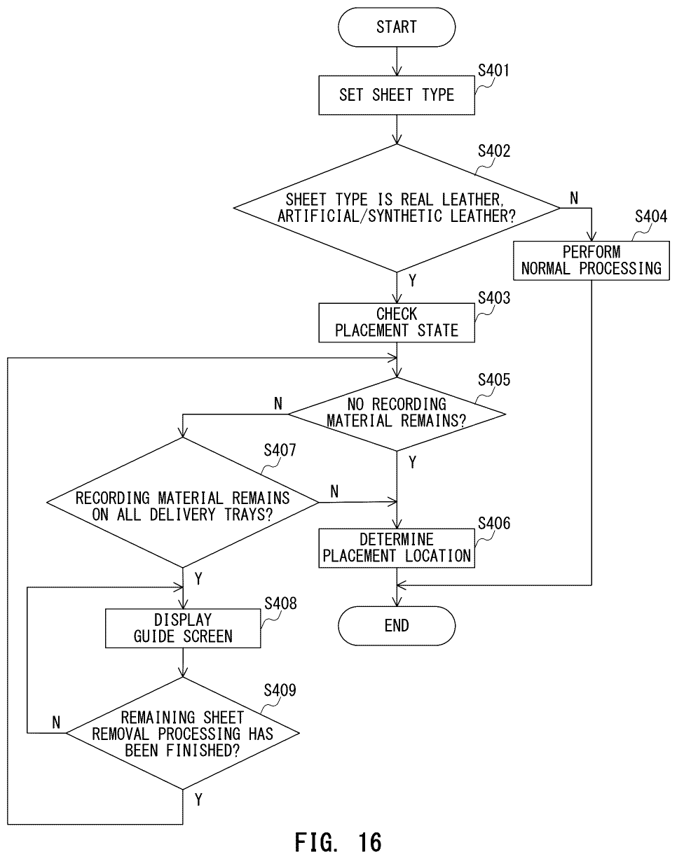

FIG. 14 is a table for showing the verification results of the cooling effect. For comparison, a similar experiment was conducted using paper having the same basis weight as synthetic leather fabric. As is clear from FIG. 14, it can be seen that in a case where the duty ratio is increased to be higher than the normal duty ratio (50%), the amount of air contacting the recording material S per unit time increases, thereby increasing the cooling effect on the recording material S, and suppressing toner peeling.

Based on the comparison with paper of the same basis weight, it can be seen that toner peeling tends to occur more for synthetic leather than for paper even when the basis weight is the same. This is because the heat capacity effect differs depending on the material. Therefore, in a case where synthetic leather is used as the recording material S, the cooling effect is required to be better than when paper is used as the recording material S. That is, this result shows that it is required to set the amount of air (duty ratio) depending on the sheet type.

In the third embodiment, air cooling is used as the cooling mechanism 247, but the cooling mechanism 247 is not limited to this, and may use a predetermined refrigerant.

### Fourth Embodiment

A placement apparatus for placing the cooled recording material S can be provided downstream of the back-end process apparatus 200. FIG. 15 is a configuration diagram of such a placement apparatus. A placement apparatus 400 includes a plurality of delivery trays 401, 402, and 403. Sensors 404, 405, and 406 for detecting a recording material S are arranged above the delivery trays 401, 402, and 403, respectively. The recording material S is delivered and placed on any one of the plurality of delivery trays 401, 402, and 403.

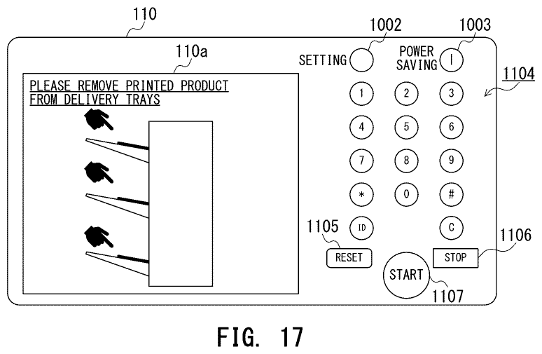

FIG. 16 is a flowchart for illustrating setting processing of the placement location of the recording material S. Description is given here of a placement apparatus 400 having a plurality of placement locations (delivery trays 401, 402, and 403) as an example, but similar processing is possible even for a placement apparatus having only a single placement location.

In the same manner as the processing step of Step S201 of FIG. 11, the main controller 101 sets the sheet type (Step S401). The main controller 101 determines whether or not the set sheet type is “real leather, artificial/synthetic leather” (Step S402). When the sheet type is not “real leather, artificial/synthetic leather” (Step S402: N), the main controller 101 sets the image forming conditions corresponding to the sheet type of the recording material S, uses the printer 120 to perform normal image formation, and delivers the recording material S to a placement location set in advance (Step S404).

When the sheet type is “real leather, artificial/synthetic leather” (Step S402: Y), the main controller 101 checks the placement state of the recording material S on each of the delivery trays 401, 402, and 403 based on the detection results of the sensors 404, 405, and 406 (Step S403). The main controller 101 checks whether or not there is a delivery tray on which a recording material S remains based on the placement state (Step S405).

When there is no delivery tray on which a recording material S remains (Step S405: Y), a recording material S is not placed on any of the delivery trays 401, 402, or 403. In this case, the main controller 101 uses the printer 120 to form an image based on the image forming conditions corresponding to “real leather, artificial/synthetic leather,” and delivers the recording material S to a predetermined placement location (Step S406). For example, the recording material S is delivered to the delivery tray 402, which has few bent portions along the conveyance path during delivery, because the recording material S is made of “real leather, artificial/synthetic leather.”

When there is a delivery tray on which a recording material S remains (Step S405: N), the main controller 101 determines whether or not a recording material S remains on all of the delivery trays 401, 402, and 403 (Step S407). When there is a delivery tray on which no recording material S remains (Step S407: N), the main controller 101 uses the printer 120 to form an image under the image forming conditions corresponding to “real leather, artificial/synthetic leather,” and delivers the recording material S to the delivery tray on which no recording material S remains (Step S406).

When all of the delivery trays 401, 402, and 403 have a recording material S remaining thereon (Step S407: Y), the main controller 101 displays a guide screen on the display 110a prompting the recording materials S to be removed (Step S408). FIG. 17 is an exemplary view of the guide screen. The user removes the recording materials S from the delivery trays 401, 402, and 403 in accordance with the guide screen.

The main controller 101 determines, based on the detection results of the sensors 404, 405, and 406, whether or not all the recording materials S have been removed from each of the delivery trays 401, 402, and 403 (Step S409). The guide screen is displayed until all the recording materials S are removed (Step S409: N). When all the recording materials S are removed (Step S409: Y), the main controller 101 returns the process to the processing step of Step S405.

When a recording material S is already placed on a delivery tray, “real leather, artificial/synthetic leather” may come into contact with the recording material S and bend. This results in a crease occurring in the delivered recording material S to be used as a printed product. When “real leather, artificial/synthetic leather” is delivered after the recording material S has been removed from the delivery tray through the above-mentioned processing, it is possible to prevent the occurrence of such creasing of the recording material S.

As described above, even when the recording material S is “real leather, artificial/synthetic leather”, it is possible to prevent the occurrence of conveyance failure. Further, deterioration in image quality is prevented. In a fourth embodiment of the present disclosure, description is given of an example in which “real leather, artificial/synthetic leather” is used as the recording material S to be printed. However, the above-mentioned processing of the fourth embodiment is effective as long as the recording material S is made of a special material other than paper that has surface properties, is of a type, and has a thickness like that of “real leather, artificial/synthetic leather.”

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064422, filed Apr. 12, 2024, which is hereby incorporated by reference herein in its entirety.

What is claimed is:

1. An image forming apparatus comprising:
an operation unit configured to allow selection between a first mode for forming an image on a first recording material which is leather and a second mode for forming an image on a second recording material which is paper;
a first placement portion on which a recording material is to be placed;
a second placement portion on which a recording material is to be placed;
an image former configured to form an image on a recording material; and
a display,
wherein a first curvature of a first conveyance path from the first placement portion to the image former is smaller than a second curvature of a second conveyance path from the second placement portion to the image former,
wherein the display is configured to display, in a case where the first mode is selected through the operation unit, a setting screen on which the first placement portion is settable as a feeding destination of the first recording material, and
wherein the display is configured to display, in a case where the second mode is selected through the operation unit, a setting screen on which one of the first placement portion and the second placement portion is settable as a feeding destination of the second recording material.

2. The image forming apparatus according to claim 1, wherein a conveyance path which conveys the recording material from the first placement portion to the image former is free of a bent portion.

3. The image forming apparatus according to claim 1, further comprising a memory configured to store an image forming condition for the first recording material,
wherein the image former is configured to form, in a case where the first mode is selected through the operation unit, an image based on the image forming condition stored in the memory.

4. The image forming apparatus according to claim 1, wherein the display is configured to display, in a case where the first mode is selected through the operation unit, a guide screen for showing a precaution in a case where the first recording material is placed on the first placement portion.

5. The image forming apparatus according to claim 1, wherein the display is configured to display, in a case where the first mode is selected by the operation unit, a setting screen on which duplex printing is unsettable.

6. The image forming apparatus according to claim 1, further comprising a cooler configured to cool the recording material on which an image has been formed by the image former,
wherein the cooler is configured to improve cooling efficiency when cooling the first recording material compared with when cooling the second recording material.

7. The image forming apparatus according to claim 6, wherein the cooler is configured to improve the cooling efficiency by adjusting a conveyance speed at which the first recording material is conveyed.

8. The image forming apparatus according to claim 6, wherein the cooler is configured to cool the recording material by blowing air onto the recording material, and to improve the cooling efficiency by adjusting an amount of the air.

9. The image forming apparatus according to claim 1, further comprising a plurality of delivery trays,
wherein the first recording material on which an image has been formed is delivered to a delivery tray to which a recording material has not been delivered.

10. The image forming apparatus according to claim 9, wherein the display is configured to display, in a case where a recording material has been delivered to all of the plurality of delivery trays, a screen instructing to remove a delivered recording material from a delivery tray.

11. The image forming apparatus according to claim 1, wherein the first recording material is made of one of leather, artificial leather, and synthetic leather as a material.

12. An information processing device which is communicably connected to an image forming apparatus,
the image forming apparatus including:
a first placement portion on which a recording material is to be placed;
a second placement portion on which a recording material is to be placed; and
an image former configured to form an image on a recording material,
wherein a first curvature of a first conveyance path from the first placement portion to the image former is smaller than a second curvature of a second conveyance path from the second placement portion to the image former,
the information processing device comprising:
an operation unit configured to allow selection between a first mode for forming an image on a first recording material which is leather and a second mode for forming an image on a second recording material which is paper; and
a display,
wherein the display is configured to display, in a case where the first mode is selected through the operation unit, a setting screen on which the first placement portion is settable as a feeding destination of the first recording material, and
wherein the display is configured to display, in a case where the second mode is selected through the operation unit, a setting screen on which one of the first placement portion and the second placement portion is settable as a feeding destination of the second recording material.
